(19) United States
(12) Patent Application Publication
(10) Pub. No.: US 2025/0287414 A1
(43) Pub. Date: Sep. 11, 2025

(54) NETWORK MANAGEMENT IN A CONGESTED ENVIRONMENT

(71) Applicant: MaxLinear, Inc., Carlsbad, CA (US)

(72) Inventors: Iñaki Val Beitia, Vitoria (ES); Sigurd Schelstraete, Menlo Park, CA (US); Marcos Martínez Vázquez, Barcelona (ES)

(73) Assignee: MaxLinear, Inc., Carlsbad, CA (US)

(21) Appl. No.: 19/075,735

(22) Filed: Mar. 10, 2025

Related U.S. Application Data
(60) Provisional application No. 63/563,262, filed on Mar. 8, 2024.

(51) Int. Cl. H04W 72/543; H04W 56/00; H04W 72/12

(52) U.S. Cl. CPC H04W 72/543; H04W 56/001; H04W 72/12

(57) ABSTRACT

A method includes arranging one or more scheduled quality of service transmit opportunities into one or more basic periods. The one or more basic periods may be operable to serve quality of service data traffic and non-quality of service data traffic. The method also includes arranging the one or more basic periods into one or more super periods. The method further includes scheduling transmissions between an access point and a station according to the one or more super periods. The transmissions may be scheduled in view of a time requirement and a throughput requirement associated with the quality of service data traffic and the non-quality of service data traffic.

### CROSS REFERENCE TO RELATED APPLICATIONS

This U.S. patent application claims priority to U.S. Provisional Patent Application No. 63/563,262, titled “SYSTEMS AND METHODS FOR NETWORK MANAGEMENT IN A CONGESTED ENVIRONMENT,” and filed on Mar. 8, 2024, the disclosure of which is hereby incorporated by reference in its entirety.

### TECHNICAL FIELD

This disclosure relates to network management, and more specifically, to network management in a congested environment.

### BACKGROUND

Unless otherwise indicated herein, the materials described herein are not prior art to the claims in the present application and are not admitted to be prior art by inclusion in this section.

Some applications and/or uses of wireless technology, such as using the Institute of Electrical and Electronics Engineers (IEEE) 802.11 standard, may include quality of service (QoS) requirements (e.g., a bounded latency and/or a reliability). As the number of such applications and use cases increase, maintaining a maximum throughput for each application may become untenable as some applications may be critical QoS services and may use more bandwidth than non-critical QoS services.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, a method may include arranging one or more scheduled quality of service transmit opportunities into one or more basic periods. The one or more basic periods may be operable to serve quality of service data traffic and non-quality of service data traffic. The method may also include arranging the one or more basic periods into one or more super periods. The method may further include scheduling transmissions between an access point and a station according to the one or more super periods. The transmissions may be scheduled in view of a time requirement and/or a throughput requirement associated with the quality of service data traffic and the non-quality of service data traffic.

In another embodiment, an access point may include a transceiver and a processing device. The processing device may be operable to arrange one or more scheduled quality of service transmit opportunities into one or more basic periods. The one or more basic periods may be operable to serve quality of service data traffic and non-quality of service data traffic. The processing device may also be operable to arrange the one or more basic periods into one or more super periods. The processing device may further be operable to schedule transmissions via the transceiver between the access point and a station according to the one or more super periods. The transmissions may be scheduled in view of a time requirement and/or a throughput requirement associated with the quality of service data traffic and the non-quality of service data traffic.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example system for network management in a congested environment;

FIG. 2 illustrates a block diagram of an example arrangement of basic periods;

FIG. 3 illustrates a block diagram of an example arrangement of super periods;

FIG. 4 illustrates an example data exchange for quality of service transmissions;

FIG. 5 illustrates an example data exchange for quality of service transmissions and non-quality of service transmissions;

FIG. 6 illustrates an example data exchange using a buffer status report preemption frame;

FIG. 7 illustrates an example time allocation;

FIG. 8 illustrates an example system arrangement to avoid collisions;

FIG. 9 illustrates another example system arrangement to avoid collisions;

FIG. 10 illustrates a flowchart of an example method of network management in a congested environment; and

FIG. 11 illustrates an example computing device.

### DETAILED DESCRIPTION

As wireless environments become more congested due to the increase of connected high-performance Wi-Fi devices, an increase in the competition for the wireless medium may become increasingly pronounced. As congestion increases and under some contention-based congestion management methods, aggregated throughput may become saturated and/or latency in the network may be affected. The saturated throughput and/or the losses in latency may affect services that may rely on particular quality of service (QoS) requirements (e.g., reliability, latency, throughput, etc.). In instances in which a network is congested, an access point (AP) in the network may compete against all non-AP stations (STAs) that may share the same channel in the network, whether the non-AP STAs are part of the same IEEE 802.11 Basic Service Set (BSS) or not. In instances in which Enhanced Distributed Channel Access (EDCA) admission control (e.g., traffic specification (TSPEC), stream classification service (SCS)) is employed, the AP may regulate the QoS traffic on the AP's BSS, but the AP may not consider the EDCA admitted traffic on an Overlapped BSS (OBSS).

One approach to address the issues herein may be for the AP to centralize and control the channel access, which may provide AP-centric scheduled operations for controlling the QoS requirements of different QoS services. Such an approach may provide higher-priority access to the AP for QoS transactions and may establish QoS scheduling coordination mechanisms between overlapping BSS (OBSS) APs. Alternatively, or additionally, EDCA mechanisms for coexistence with non-QoS services and legacy devices may be retained for continuing support of the non-QoS services and legacy devices. In some instances, a legacy (non-AP) device may include only an EDCA mechanism, such as a pre-802.11ax device (e.g., may be active at 2.4 GHz and/or 5 GHz bands). Alternatively, or additionally, a legacy device may support trigger-based access (e.g., post-802.11ax devices) that may be active at 5 GHz bands (coexistence with the EDCA devices) and/or 6 GHz bands. In some instances, the trigger-based legacy devices may be operable to support QoS requirements, which may be announced to the AP using SCS requests.

Some existing IEEE 802.11 features may offer approaches to addressing some of the issues described herein, but may include one or more shortcomings. For example, a first shortcoming may include APs struggling to access a channel when many STAs are contending at the same time, which may cause difficulties in scheduling the network. Some features for adapting STA's EDCA parameters may exist, but the features may offer only a partial solution. In a second example, the QoS management may be limited to the BSS associated with the AP. Ensuring QoS in the presence of OBSS may be difficult or not possible. In a third example, no coordination mechanisms may exist designed to facilitate cooperation between APs, including covering the OBSS and Extended Service Set (ESS) cases.

In at least some embodiments of the present disclosure, scheduled QoS transmit opportunities may be organized into basic periods and/or super periods, that may be in view of various time requirements and/or throughput requirements. Each basic period may be operable to serve QoS data traffic and/or non-QoS data traffic (e.g., legacy data traffic), and may be determined in view of airtime fairness rules. Alternatively, or additionally, a preemptive buffer status report (BSR) mechanism may be implemented that may facilitate a low overhead mechanism for transmitting uplink transmission requirements from a station to an AP.

In an OBSS and/or ESS scenario, coordinated QoS transmit opportunity scheduling may be enabled via a synchronization between the AP timing synchronization function counters. Alternatively, or additionally, coordinated QoS transmit opportunity scheduling may be enabled via an agreement on coordination based on a multi-AP coordinated time-division multiple access (TDMA).

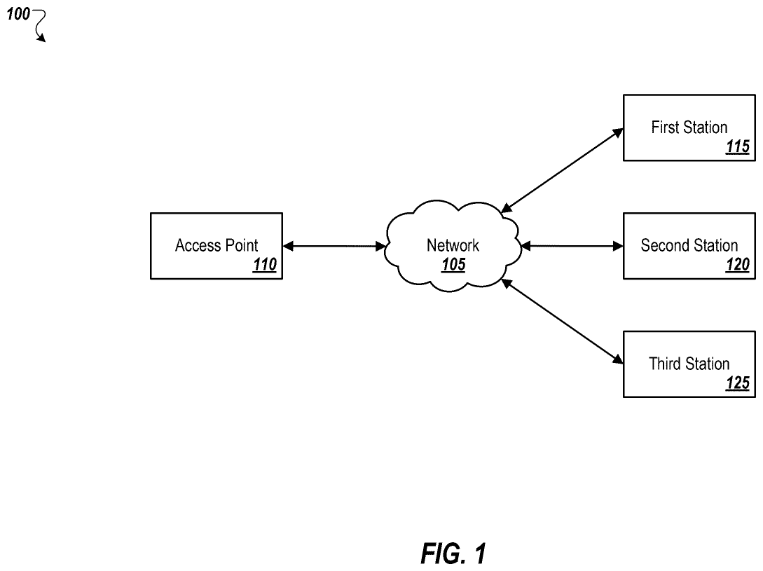

FIG. 1 illustrates a block diagram of an example system 100 for network management in a congested environment. The system 100 may include a network 105, an access point 110, a first station 115, a second station 120, and a third station 125.

The network 105 may be a wireless network operable to support transmissions between at least the AP 105 and the first STA 115, the second STA 120, and/or the third STA 125. As described, the network 105 may support communications according to the IEEE 802.11 standard, and/or may support QoS requirements for the transmissions. The AP 110 may be a representation of the APs described in the following figures, and the STAs described in the following figures may be represented by any of the first STA 115, the second STA 120, and/or the third STA 125. Any of the first STA 115, the second STA 120, and/or the third STA 125 may be operable to support QoS transmissions and/or non-QoS transmissions, such that any of the first STA 115, the second STA 120, and/or the third STA 125 may be a QoS device or a legacy device.

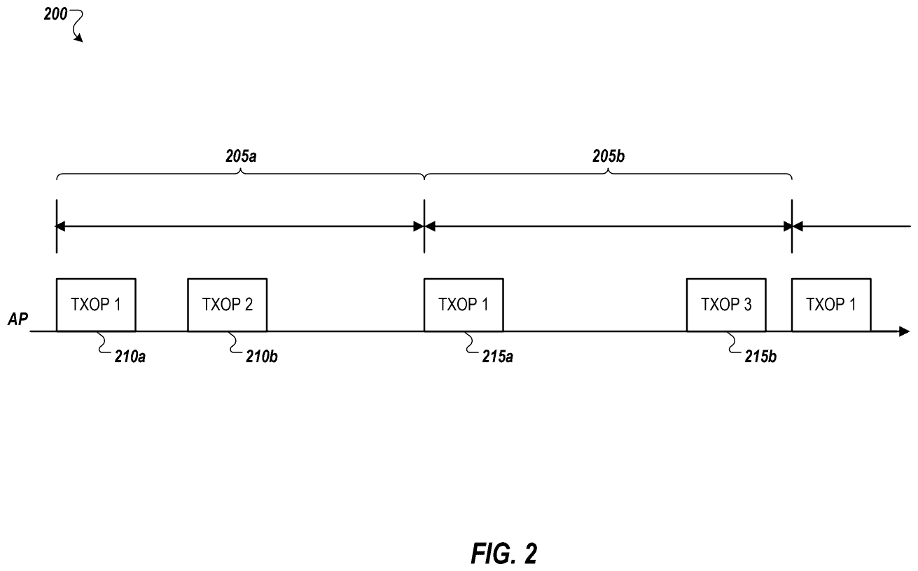

FIG. 2 illustrates a block diagram of an example arrangement 200 of basic periods, namely a first basic period 205a and a second basic period 205b. Using AP QoS scheduling, a packet exchange between an AP and STA nodes in an IEEE 802.11 network can be sequenced with a previously granted Transmit Opportunity (TXOP), such as a first TXOP 210a and a second TXOP 210b in the first basic period 205a, and a third TXOP 215a and a fourth TXOP 215b in the second basic period 205b. The sequence may facilitate scheduling different downlink (DL) and uplink (UL) transactions and executing the different DL and UL transactions automatically, following some throughput and time requirements that may be managed by the AP. The AP may collect SCS requests and/or may allocate periodic QoS TXOPs within a basic period, as described.

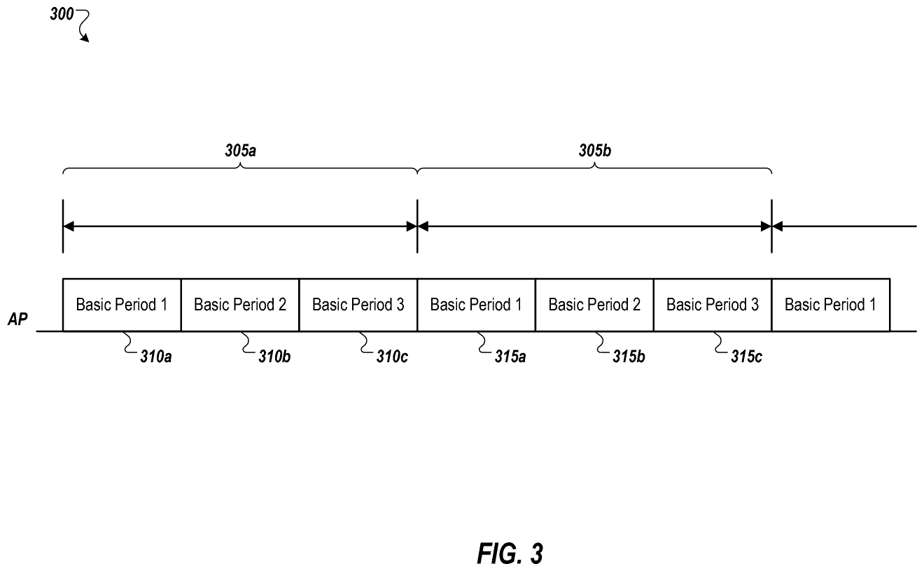

FIG. 3 illustrates a block diagram of an example arrangement 300 of super periods, namely a first super period 305a and a second super period 305b. In some instances, a number of basic periods (e.g., the first basic period 205a and the second basic period 205b of FIG. 2) may be included in a longer super period, such as the first super period 305a and the second super period 305b.

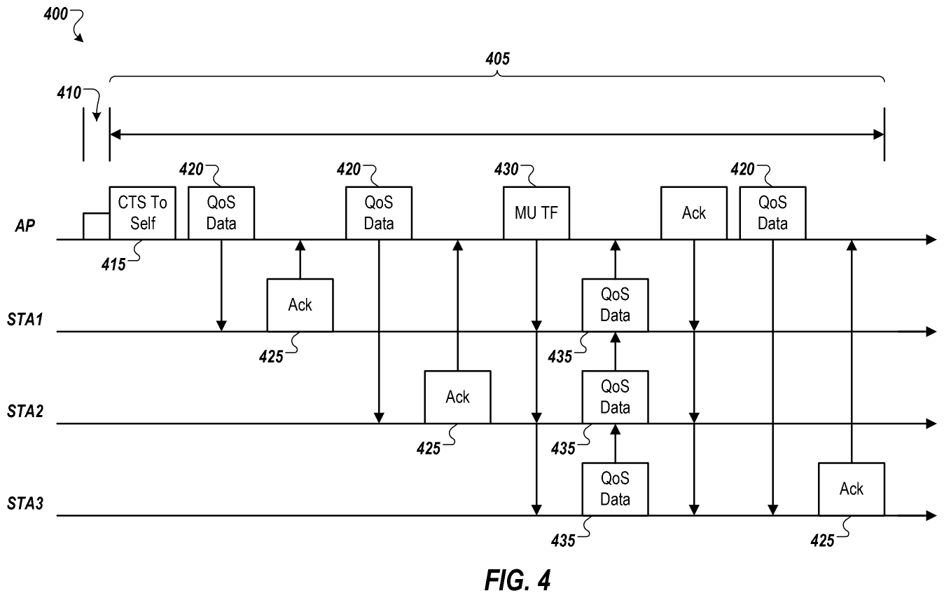

FIG. 4 illustrates an example data exchange 400 for quality of service transmissions. For each QoS TXOP 405, a restricted target wake time (TWT) service period may be present, which may direct the BSS STAs that support restricted TWT to end their transmissions before the service period (SP) begins. Not all STAs may implement restricted TWT and the AP may facilitate channel access for QoS TXOP by using prioritized channel access. In instances in which a channel becomes idle, the AP may wait for point inter frame space (PIFS) 410 without backoff to obtain a higher access priority to the medium. This operation may be limited over the time, at least enough to cover the QoS requirements and maintain airtime fairness for other EDCA and legacy devices. Each QoS TXOP may be used to exchange DL/UL data with the managed STAs that previously have requested resources. The AP may obtain a clear to send (CTS) 415 frame for itself before beginning to transmit. After which, the AP may periodically send QoS data 420 to the various STAs and receive an acknowledgement (ACK) 425 from each in response to the STAs obtaining the QoS data 420. In some instances, the AP may be operable to transmit a multi-user trigger frame (MU TF) 430 to each of the STAs, and each of the STAs may respond with the STA QoS data 435.

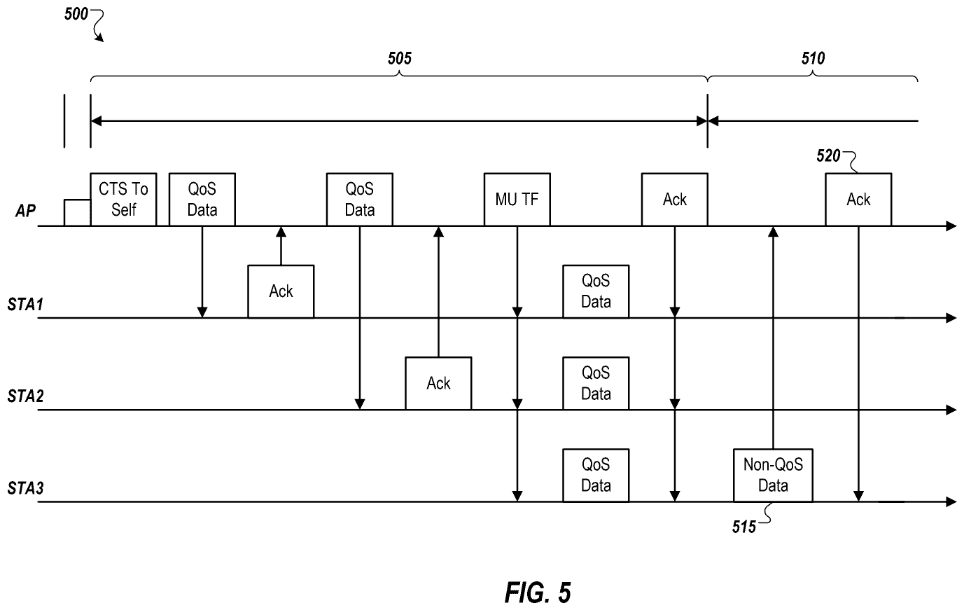

FIG. 5 illustrates an example data exchange 500 for quality of service transmissions and non-quality of service transmissions. As shown in FIG. 2, the gaps between QoS TXOPs (e.g., the first TXOP 210a, the second TXOP 210b, etc.) may allow legacy EDCA devices to access the channel using contention rules. After a QoS TXOP 505 ends, the channel may become free for non-QoS exchanges 510 and the legacy devices and/or non-QoS devices may start contending for the medium for transferring data in DL or UL direction. For example, once the non-QoS exchanges 510 have access to the transmission medium, the non-QoS data 515 from STA3 may be transmitted to the AP. In response, the AP may transmit and ACK 520 to STA3. As can be seen in the QoS TXOP 505 portion of FIG. 5, it may be the same or similar to the QoS TXOP 405 illustrated in FIG. 4.

Some legacy trigger based (TB) capable devices may prefer an allocation within the QoS TXOP 505, but the AP may not know the status of uplink buffers of the legacy TB capable devices. The legacy TB capable devices may be operable to announce their buffer status by a QoS control field declaring the queue size waiting to be sent. In some instances, the QoS control field may have a value of zero, as the data may have already been sent in the QoS data frame that contains such QoS control field. As a result, the queue might be empty. Alternatively, or additionally, a BSR and/or BSR polling (BSRP) messages may allow the AP to ask the STA about a buffer status of the STA. The message exchange may generate an overhead in the network.

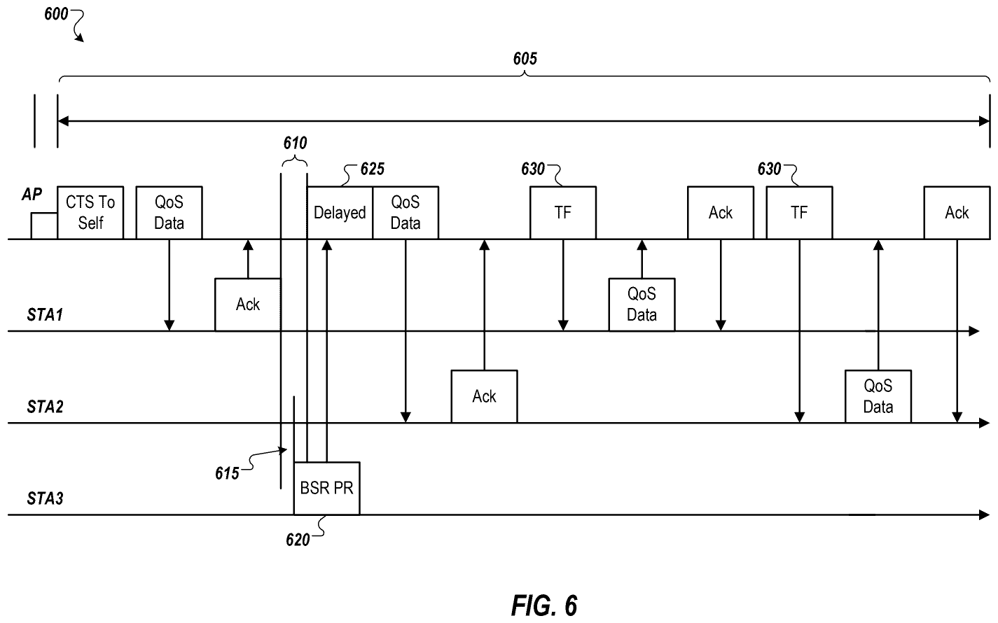

FIG. 6 illustrates an example data exchange 600 using a BSR preemption frame. The BSR preemption frame may utilize a preemption request (PR) frame, which may carry the BSR of an STA. Some of the data exchange 600 may be the same or similar as the data exchange 500 of FIG. 5 and/or the data exchange 400 of FIG. 4. As such, the differences may be specifically noted in FIG. 6. For example, each of the QoS data blocks from the AP may have PR frames enabled while the trigger frame (TF) blocks 630 may have PR frames disabled.

The BSR PR frame 620 may be operable to overcome the above drawbacks, based on data preemption. The AP may signal where the PR may be sent and/or may assign a specific time window within the QoS TXOP 605. The QoS TXOP 605 may not be interrupted by preemption data exchanges, as an interruption may break the entire scheduling of QoS applications. Therefore, in some instances, only BSR PR frames 620 may be allowed. Once the AP processes the BSR PR frame 620, the AP may allocate resources on the next QoS TXOP.

In some instances, the BSR PR frame 620 may interrupt the scheduled data sequence (e.g., when the Tp value 615 is less than the inter-frame space (xIFS, where ‘x’ may denote various inter-frame spaces) value 610, or Tp<xIFS). Once the PR ends, the AP may recover the control and may restart the planned scheduled transactions, which may have been delayed 625 for a BSR PR time length.

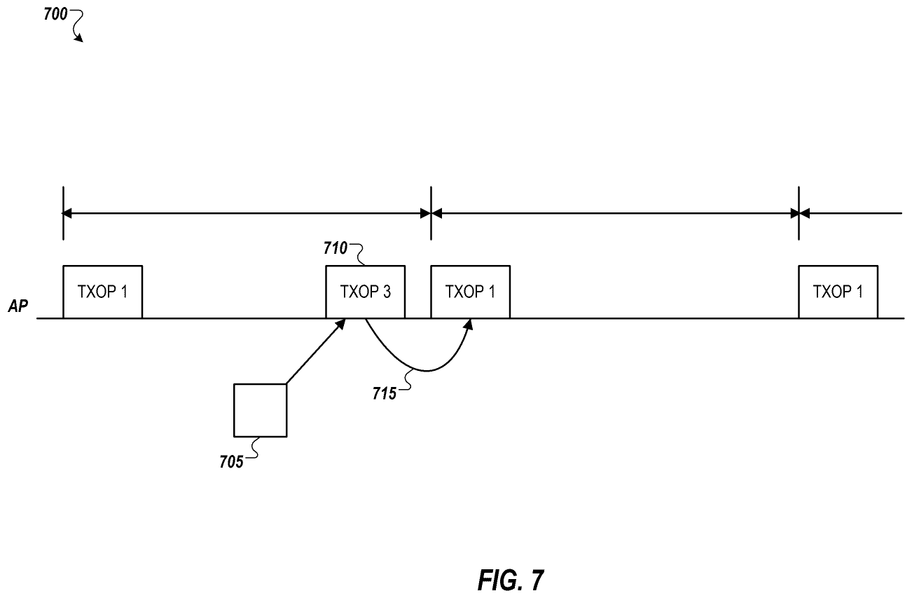

FIG. 7 illustrates an example time allocation 700, where a STA3 UL data could be scheduled in the next QoS TXOP, being able to manage the preemption in a controlled and predictable situation. For example, STA3 may report a buffer status 705 to the AP during a third TXOP 710, and the AP may be operable to schedule 715 STA3 for transmission during a next TXOP. FIG. 7 illustrates a time allocation for a UL request based on BSR PR.

In instances in which OBSS may be implemented, the network devices in the network may contend for the channel. While the previously described methods may be operable within the BSS environment, a different solution may be needed for the OBSS environment. The overlapped networks may need a coordination mechanism such that each network may be operable to satisfy its own QoS requirements, under the capacity limitations of the wireless channel. Consider two possible scenarios, first, the interferer OBSS includes a QoS AP, and second, the interferer OBSS has a non-QoS AP (or a legacy AP). The following description may be in view of instances in which all the nodes may see each other. Or in other words, all of the nodes may be within Energy Detection (ED) range and/or Packet Detection (PD) range. Alternatively, or additionally, although described relative to OBSS scenarios, the subsequent description may be applicable to ESS scenarios as well.

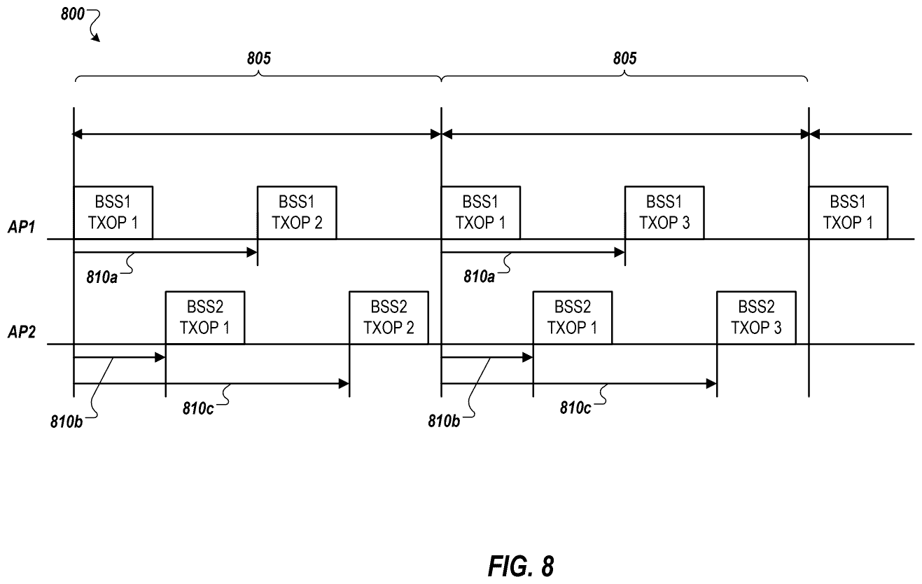

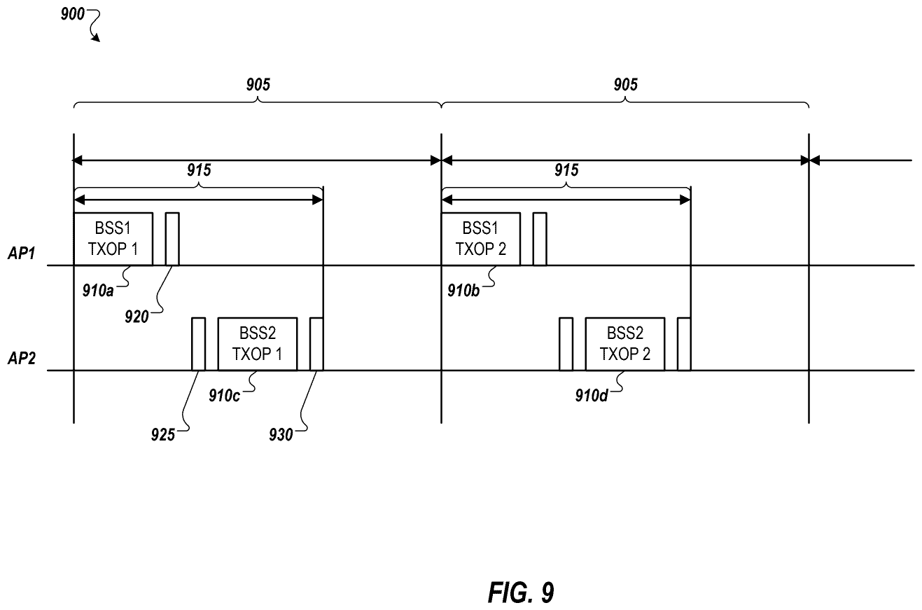

In instances in which ultra high reliability (UHR) QoS APs are uncoordinated, at least with respect to one another, two QoS TXOPs may collide during transmission. In instances in which the two QoS TXOPs have the same high-priority channel access, the probability of collision may increase. Ensuring that timing synchronization function (TSF) counters are synchronized between the APs, two possible mechanisms could avoid the collision problem. First, the beginning of the basic period and/or the super period may be synchronized, where the APs may agree on the execution of the QoS TXOPs of each AP, and/or not overlapping each other. FIG. 8 illustrates the first mechanism. Second, a basic period length may be agreed upon and/or a sharing AP may be established that may lead the QoS TXOPs in both APs by means of a Multi-AP Coordinated TDMA mechanism. FIG. 9 illustrates the second mechanism.

FIG. 8 illustrates an example system arrangement 800 to avoid collisions, where a coordination between QoS APs may be based on a time synchronization. As illustrated, the QoS APs may agree on time offsets 810 (time offset 1 810a, time offset 2 810b, time offset 3 810c, etc.) to execute the scheduled QoS TXOPs within each basic period 805. The time offsets 810 may be referenced to the initial point of the basic period 805, which may be used to time synchronize the APs, and/or avoid collisions. The agreement between the APs may be performed by exchanging the QoS TXOP information through specific control/management frames. Restricted TWT could leverage the time synchronization provided by the APs. The gaps between the QoS TXOPs may follow the EDCA rules. The synchronization may be performed by synchronizing the TSF counters of each AP, and/or by calculating the time offset of both free-running TSF counters.

FIG. 9 illustrates an example system arrangement 900 to avoid collisions, where a coordination between QoS APs may be based on a multi-AP scheme. As shown in FIG. 9, the QoS APs may agree on the basic period length 905 and the QoS TXOPs 910 that may be executed along these periods. The sharing AP (AP1 in FIG. 9) may start the basic period 905, executing the sharing AP QoS TXOP 910a and after finishing, the sharing AP may share the remaining TXOP time 915 (e.g., Coordinated TDMA) to the shared AP (AP2 in FIG. 9) for executing the shared AP QoS TXOP 910c. The sharing AP may transmit a transmission request to send trigger frame 920 to the shared AP and the shared AP may transmit a CTS frame before beginning the shared AP QoS TXOP 910c. Upon completion, the shared AP may transmit a contention free end frame 930. The agreement between the sharing AP and the shared AP can be done by exchanging the QoS TXOP information through a multi-AP framework. Like in the first mechanism, the gaps between the Basic Periods may follow the EDCA rules.

In instances in which a legacy AP and/or a non-QoS AP is present in the OBSS implementation, the QoS AP may have an advantage in contending for the channel concerning the legacy/non-QoS AP. In view of promoting fairness between the non-QoS AP and the QoS AP, the TXOP length acquired by the QoS AP may be limited. Mechanisms such as Coordinated TDMA may facilitate the QoS AP sharing the TXOP with the non-QoS AP. In some instances, legacy APs may not have a coordination mechanism available.

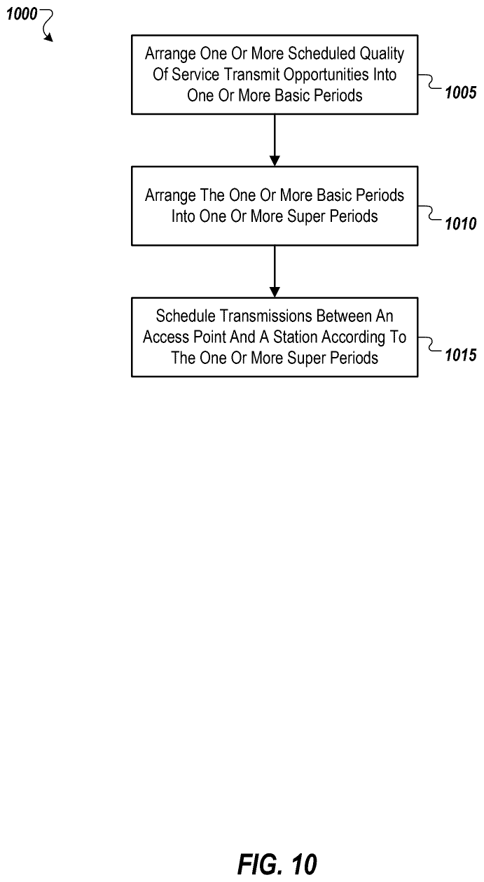

FIG. 10 illustrates a flowchart of an example method 1000 of network management in a congested environment. The method 1000 may be performed by processing logic that may include hardware (circuitry, dedicated logic, etc.), software (such as is run on a general purpose computer system or a dedicated machine), or a combination of both, which processing logic may be included in any computer system or device such as the access point 110 of FIG. 1.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

At block 1005, one or more scheduled quality of service transmit opportunities may be arranged into one or more basic periods. In some instances, the one or more basic periods may be operable to serve quality of service data traffic and non-quality of service data traffic.

At block 1010, the one or more basic periods may be arranged into one or more super periods.

At block 1015, transmissions between an access point and a station may be scheduled according to the one or more super periods. In some instances, the transmissions may be scheduled in view of a time requirement and/or a throughput requirement associated with the quality of service data traffic and the non-quality of service data traffic.

In some instances, a first transmission of the transmissions may be a quality of service transmission, and/or a second transmission of the transmissions may be a non-quality of service transmission. In some instances, the second transmission may be scheduled for transmission following completion of the first transmission. In some instances, the second transmission may be from a trigger based station. In some instances, the trigger based station may announce a buffer status using a quality of service control field. Alternatively, or additionally, the trigger based station may announce a buffer status by responding to a buffer status report request from the access point. In some instances, the trigger based station may include a preemption request frame to carry the buffer status report to the access point. In some instances, the access point may be configured to allocate transmission resources in a next transmit opportunity for the preemption request frame

Modifications, additions, or omissions may be made to the algorithm as described without departing from the scope of the present disclosure. For example, timing between the access point and a second access point may be synchronized. In some instances, the transmissions between the second access point and a second station may be scheduled using the timing and/or in view of the time requirement and the throughput requirement. In some instances, the timing between the access point and the second access point may be synchronized at a beginning of the one or more basic periods and/or the one or more super periods. Alternatively, or additionally, the timing between the access point and the second access point may be synchronized by the access point and the second access point agreeing on a length of the one or more basic periods and/or one of the access point and the second access point may be designated as a lead access point to direct the scheduled quality of service transmit opportunities.

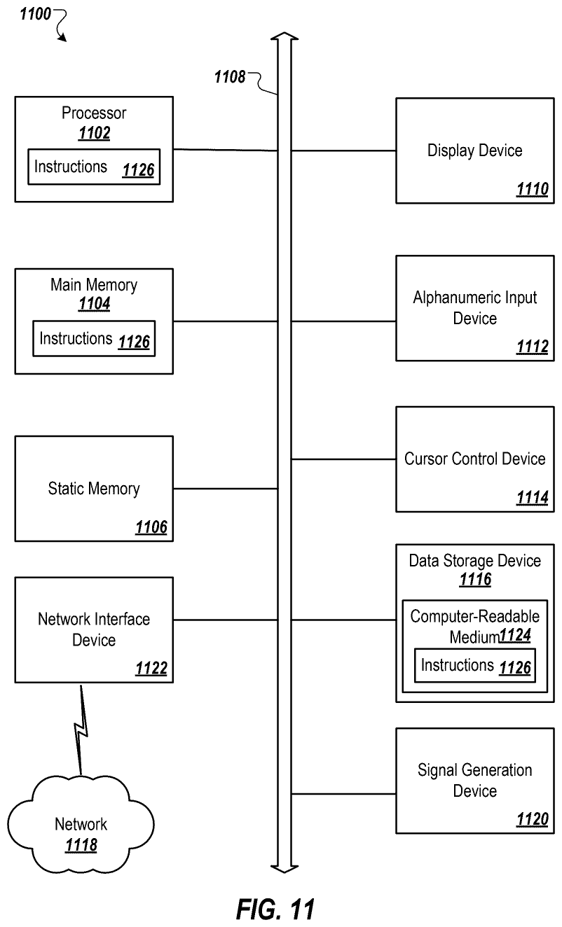

FIG. 11 illustrates an example computing device 1100 within which a set of instructions for causing the machine to perform any one or more of the methods discussed herein may be executed. The computing device 1100 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions for causing the machine to perform any one or more of the methods discussed herein may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 1100 can include a processing device 1102 (e.g., a processor), a main memory 1104 (e.g., read-only memory (ROM), flash memory, dynamic random access memory (DRAM) such as synchronous DRAM (SDRAM)), a static memory 1106 (e.g., flash memory, static random access memory (SRAM)) and a data storage device 1116, which communicate with each other via a bus 1108.

The processing device 1102 represents one or more general-purpose processing devices such as a microprocessor, central processing unit, or the like. More particularly, the processing device 1102 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1102 may also include one or more special-purpose processing devices such as an application specific integrated circuit (ASIC), a field programmable gate array (FPGA), a digital signal processor (DSP), network processor, or the like. The processing device 1102 is configured to execute instructions 1126 for performing the operations and steps discussed herein.

The computing device 1100 may further include a network interface device 1122 which may communicate with a network 1118. The computing device 1100 also may include a display device 1110 (e.g., a liquid crystal display (LCD) or a cathode ray tube (CRT)), an alphanumeric input device 1112 (e.g., a keyboard), a cursor control device 1114 (e.g., a mouse) and a signal generation device 1120 (e.g., a speaker). In at least one implementation, the display device 1110, the alphanumeric input device 1112, and the cursor control device 1114 may be combined into a single component or device (e.g., an LCD touch screen).

The data storage device 1116 may include a computer-readable storage medium 1124 on which is stored one or more sets of instructions 1126 embodying any one or more of the methods or functions described herein. The instructions 1126 may also reside, completely or at least partially, within the main memory 1104 and/or within the processing device 1102 during execution thereof by the computing device 1100, the main memory 1104 and the processing device 1102 also constituting computer-readable media. The instructions may further be transmitted or received over a network 1118 via the network interface device 1122.

While the computer-readable storage medium 1124 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding, or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

A number of implementations have been described. Nevertheless, it will be understood that various modifications may be made without departing from the spirit and scope of the disclosure. Accordingly, other implementations are within the scope of the following claims.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
arranging one or more scheduled quality of service transmit opportunities into one or more basic periods, the one or more basic periods operable to serve quality of service data traffic and non-quality of service data traffic;
arranging the one or more basic periods into one or more super periods; and
scheduling transmissions between an access point and a station according to the one or more super periods, in view of a time requirement and a throughput requirement associated with the quality of service data traffic and the non-quality of service data traffic.

2. The method of claim 1, wherein:
a first transmission of the transmissions is a quality of service transmission;
a second transmission of the transmissions is a non-quality of service transmission; and
the second transmission is scheduled for transmission following completion of the first transmission.

3. The method of claim 2, wherein the second transmission is from a trigger based station.

4. The method of claim 3, wherein the trigger based station announces a buffer status using a quality of service control field.

5. The method of claim 3, wherein the trigger based station announces a buffer status by responding to a buffer status report request from the access point.

6. The method of claim 5, wherein the trigger based station comprises a preemption request frame to carry the buffer status report to the access point.

7. The method of claim 6, wherein the access point is configured to allocate transmission resources in a next transmit opportunity for the preemption request frame.

8. The method of claim 1, further comprising:
synchronizing timing between the access point and a second access point; and
scheduling the transmissions between the second access point and a second station using the timing and in view of the time requirement and the throughput requirement.

9. The method of claim 8, wherein the timing between the access point and the second access point is synchronized at a beginning of the one or more basic periods and the one or more super periods.

10. The method of claim 8, wherein the timing between the access point and the second access point is synchronized by:
the access point and the second access point agreeing on a length of the one or more basic periods; and
one of the access point and the second access point is designated as a lead access point to direct the scheduled quality of service transmit opportunities.

11. An access point, comprising:
a transceiver; and
a processing device, operable to:
arrange one or more scheduled quality of service transmit opportunities into one or more basic periods, the one or more basic periods operable to serve quality of service data traffic and non-quality of service data traffic;
arrange the one or more basic periods into one or more super periods; and
schedule transmissions via the transceiver between the access point and a station according to the one or more super periods, in view of a time requirement and a throughput requirement associated with the quality of service data traffic and the non-quality of service data traffic.

12. The access point of claim 11, wherein:
a first transmission of the transmissions is a quality of service transmission;
a second transmission of the transmissions is a non-quality of service transmission; and
the second transmission is scheduled for transmission following completion of the first transmission.

13. The access point of claim 12, wherein the second transmission is from a trigger based station.

14. The access point of claim 13, wherein the trigger based station announces a buffer status using a quality of service control field.

15. The access point of claim 13, wherein the trigger based station announces a buffer status by responding to a buffer status report request from the access point.

16. The access point of claim 15, wherein the trigger based station comprises a preemption request frame to carry the buffer status report to the access point.

17. The access point of claim 16, wherein the access point is configured to allocate transmission resources in a next transmit opportunity for the preemption request frame.

18. The access point of claim 11, wherein the processing device is further operable to:
synchronize timing between the access point and a second access point; and
schedule the transmissions between the second access point and a second station using the timing and in view of the time requirement and the throughput requirement.

19. The access point of claim 18, wherein the timing between the access point and the second access point is synchronized at a beginning of the one or more basic periods and the one or more super periods.

20. The access point of claim 18, wherein the timing between the access point and the second access point is synchronized by:
the access point and the second access point agreeing on a length of the one or more basic periods; and
one of the access point and the second access point is designated as a lead access point to direct the scheduled quality of service transmit opportunities.
